(19) United States
(12) Patent Application Publication
(10) Pub. No.: US 2016/0219039 A1
(43) Pub. Date: Jul. 28, 2016

(54) Mobile Authentication Method and System for Providing Authenticated Access to Internet-Sukpported Services and Applications

(71) Applicants: Mario HOUTHOOFT, Sint-Martens Latem (BE); Dieter HOUTHOOFT, Melle (BE); LIN.K N.V., Melle (BE)

(72) Inventors: Mario Houthooft, Sint-Martens Latem (BE); Dieter Houthooft, Melle (BE)

(21) Appl. No.: 14/917,140

(22) PCT Filed: Sep. 8, 2014
(86) PCT No.: PCT/BE2014/000043

§ 371 Date: Mar. 7, 2016

(30) Foreign Application Priority Data
Sep. 6, 2013 (BE) 2013/0586

(51) Int. Cl. H04L 29/06; H04W 12/06

(52) U.S. Cl. CPC H04L 63/0815; H04L 63/0838; H04W 12/06; H04L 63/083

(57) ABSTRACT

This invention relates to a system comprising a unified identity management system (2) for the users (3) within a certain area on which it is centered intended to create a unified identity means (23) with which the user one and the same account employs to make themselves known, and this to authenticate for various applications based on different application containers (63). For instance, users (3) access to multiple applications using 1 bill. The authentication process implements a two- factor authentication is based on a knowledge and possession factor, with the use of specific codes, and a two-stage mechanism to achieve a user experience, which is remarkable in that the authentication mechanism is provided with mobile detection means for detecting whether there are 2 copies of the same mobile registration active which action to take if this is the case. The user experience comprises two main steps: scanning a QR tag and the attachment of the context to provide by insertion of a PIN code.

### FIELD OF THE INVENTION

The present invention relates to an “Internet” system that is based on an apparatus for providing authenticated access to the Internet-supported services and applications.

### BACKGROUND OF THE INVENTION

The breakthrough of the Internet in everyday life has made this a lot easier with the wide range of applications that are now available therewith offering up to a true revolution that have fundamentally changed many customs and habits. Due to the ever growing capabilities and applications that were opened this including some originally freely accessible, were laid gradually restrict which user was asked to register in order to have an access to the desired web services. With many web services having become of daily use, the identification problem became almost unmanageable, given the ever increasing number of user names and passwords for each Web service on each occasion to be remembered and therefore kept separately by the user. This whole identification process soon turned into a hopeless task. Regular web service users had to go through cumbersome procedures to retrieve forgotten login data indeed, or even to create a new account, even if in the meantime a different email address was used by the user, for those who use multiple email addresses, depending on the circle in which he is engaged.

To remedy this, his credentials can be stored on the computer, but this is only when the user logs on that one device. However, this is not always possible, such as when the user must have access to its desired web service via another computer device, when he is in a different environment. Moreover, a further disadvantage is that the more the user stores, the easier it is for hackers to hijack all that personal information. So this clearly states a security problem that may become critical for the regular user. This therefore creates a true identity jungle, with the aim here is to prune them thoroughly.

It is well known that conditions wherein a user is in possession of a multiplicity of passwords in order to gain access to a wide variety of websites cause a problem for the user: it becomes somewhat difficult for the user after a while to remember the passwords properly in order for them to be used correctly with regard to a required website. To remedy this, a number of management systems have been developed which provide access to a multiplicity of computers via the Internet by means of one single authentication process.

### STATE OF THE ART

A system of this type is known from WO 2009/018564 of RITARI. A single-sign-on user account known as SSO is disclosed herein, as well as a set of websites with protected access which are linked to the SSO user account, and various user identification IDs and password combinations that are linked with the set of access-protected websites. A computer program which is installed on a local computer is configured to enter in advance the so called log-in and password intended for the access-protected websites.

A further system is also disclosed in WO 2008/024454, in which a trusted platform module referred to as TPN is described, which cooperates with a so-called PROXY SSO unit and with access applications to the web to generate, store and search for passwords in so-called SSO credentials. The same problem is again raised herein that the user is faced to a constantly growing number of passwords every time he wishes to get access to a new website or wishes to re-activate one.

With the constant increase in electronic transactions and all kinds of Internet-related operations, the protected use of a suitable identification during the operations on the Internet has become a critical problem that resulted in the setting up of Internet models for the identification and management of the user, who is normally registered with a well-defined username and password linked to a specific domain, with the aim of hindering theft or even any unauthorized use of the identification by a third party from site to site. Models of this type, referred to here as application-oriented identity models, are characterised by a strong support for domain management, but nevertheless reveal scaling and flexibility limitations as soon as they are faced with more extensive identity requirements of Internet scenarios.

Known authentication systems tend to be rather oriented on an application basis, having the disadvantage that they entail severe limitations for both users and agents or service providers of the intended applications. The latter remain locked into one authentication method or technology to which they are restricted indeed. Furthermore, they have an increasing total cost of ownership (TCO) in facilities, for maintaining a helpdesk and the like. The latter also have to contend with the quality of the user data, such as problems of double use, false data, or even data that are no longer current. In addition, they have little or even no mutual exchange at all among the applications, neither cross-marketing nor cross-costing known as TCO. Furthermore, they must provide support for privacy conformity.

As far as the users are concerned, they are somehow forced to use specific authentication means dedicated to the application. Furthermore, they experience difficulties in maintaining their credentials. They are similarly unable to enjoy multiple reciprocal authentication/application interaction. Finally, they reveal an increasing concern relating to the control and management of their identity, their credentials and their privacy.

### THE AIM OF THE INVENTION

The object of the present invention is likewise to find a solution to the aforementioned drawbacks and problems, but in a more sophisticated manner that is based on an innovative combination of a number of elements, resulting in a more powerful system thanks to which highly practical and inventive applications using the possibilities of the Internet are created thanks to a user-oriented identity management system.

### SUMMARY OF THE INVENTION

According to the present invention, a system is thus proposed as defined in the attached main claim, wherein according to a main embodiment, the mobile authentication method proposed with the present invention implements a 2-factor authentication that is based on both a knowledge factor and possession factor. It uses QR codes and a 2-phase commit sequence to create a secure, stable and smooth user experience. The authentication process can be extended to confirm and configure additional items, such as privacy settings, terms and conditions, and payments.

A first step in developing a solution to remedy the abovementioned problems is to make use of a mobile device, such as, in particular, a so-called smart phone or a tablet, which thereby serves as a key to the desired web services and web sites that the user wants to apply. Mobile devices are everywhere indeed, and we carry them around wherever we go. This makes mobile devices prime candidates for making them part of a 2 factor authentication mechanism, since the user doesn't have to carry an additional device in that case.

A mobile device also has a keyboard and display that might be separated from the display and keyboard being used to run the main application. The separated display can show a context about what should be happening on the main display. It generates trust by asserting that the main display really shows what is going on, and is thus not a fraudulent application.

The separated keyboard allows for a secure entry of the possession factor. Users don't have to use the keyboard of the other, possibly not trusted device on which the main application runs.

The current-generation devices are also provided with a good camera, suited for fast QR scanning and often have additionally an always-on Internet connection. Both can be used to create a real smooth and secure user experience. The QR code scanning allows for quick and error-free synchronization of the main application and the mobile application.

In other 2-factor authentication methods, the possession factor is often implemented using some kind of secure element, like a smart card, which can only be unlocked by the knowledge factor, often a PIN code. The linked mobile authentication system according to the invention implements a 2-factor authentication. It is based on both a knowledge factor and a possession factor. It uses QR codes and a 2-phase commit mechanism so as to generate a secure, stable and fluent users experience. In contrast, the possession factor in the mobile authentication system according to the invention is implemented entirely in software as secure elements are not widely available on the current mobile devices.

A secure element cannot be copied within reasonable and payable limits. In contrast, the possession factor according to the invention, which is based on data and code in memory, can be copied by malicious code running on the mobile device or by insecure backup practices. To counter this loss of protection, the mobile authentication mechanism according to the invention is built up such that it is able to detect if 2 copies of the same registered mobile device are being used and take appropriate action if this should be the case.

A first advantage of this invention thus consists of the far-reaching simplification in the use of the Internet and web services thus available, thanks to the elimination of the chaotic multiplicity of passwords, and all kinds of codes, which has now become totally out of control, in that their number could finally be reduced to a single binomial or couple, which is much easier to remember by the user of course. This is just the direct result of the remarkable structure of the system according to the invention, wherein it is the user of the software who is placed in the center of the system instead of the software application that he wants to use.

A further significant advantage of the invention consists in the enhanced security of the system, particularly against hackers who get less chance to parasitize the large multiplicity of personal information that would otherwise be inserted in each case as indicated above. This system also works quite simply as indicated below. The user comes to a website that uses the system, wherein the user may scan a QR code. Then, the user enters his PIN on his mobile device and he is thus submitted. It's that simple. The user is also able to order products and/or pay with the same ease.

The user decides what information he wants to share with any application or website. This link system according to the invention can also make a link in a remarkable way with the data on the electronic identity (eID), which is useful for government applications. The system then remembers which data may be displayed to which application. If something changes on the user's personal information, such as a new address after a move, this is adjusted by itself everywhere.

Thanks to this mobile solution, the user recovers control over his own personal information, which is a decisive factor in the enhanced security of the system of the invention against the known system.

The app makes it also possible that the applications that the user is using, exchange their own information with each other. This allows them to set up joint commercial actions, such as newspapers giving their subscribers discount on products from partner companies. It is true that more and more companies in a privileged way to collaborate with other companies of their choice. Now, this invention provides an excellent opportunity to support this privileged partnership with manageable tools.

Furthermore, it is emphasized that the system is a neutral platform, in the meaning that it does not depend on a Telecom operator or a financial operator of the bank type, or any other operator or sponsor.

Moreover, the data are not stored on the mobile device of type smart-phone itself, allowing the user not to lose his whole identity in case of loss or theft of his mobile device. All data are thus secured, stored in a so-called cloud on servers that are hosted by the government in a secure way under the exclusion of their own mobile device that the user used during the authentication process or for the use thereof.

A further aspect of this invention consists in that it is perfectly susceptible to an efficient expansion of its potentialities. Indeed, in order to further spread out the link system according to the invention, a range of useful apps that make use of it is developed, still in the context of this invention as it were by a kind of nest structure.

An example thereof consists of the known app called i Wish, which allows to set up wish lists of interesting products. This works by scanning in the bar code of a particular product such as a book, allowing this to be added to the virtual wish list of the user. In an analogous manner, a similar app around wines is in development, and further a payment application as well.

Still in the context of the pursuit of a still further increasing development and dissemination of the system, other key players may be involved in a partnership as well.

It is known that in the increasingly crowded digital world, which the web sub-world also belongs to, cybercrime still continues to grow and this exponentially. The worldwide publicity surrounding recent spying scandals resulted in that everyone is now really aware that one must take the necessary organizational and technical measures around information protection. As a matter of fact, the present invention provides a useful contribution to this problem by significantly improving the security of personal data by making it less exposed to the hijacker work of hackers. The aim is clearly to increase digital security in an efficient attempt to prevent an organization from being hit hard by cybercrime. An effective way to get prepared against cyber attacks, consists of the use of the link system according to the invention, which is in fact a simplified form of cyber security management CSM which involves more than the traditional securing of information as known from the prior art.

In short, thanks to the system proposed by the invention, everything can be accomplished through one single application run that manages all the users identity, including both sign up, register, buy, pay, etc.

It is specific to the system according to the invention that it is the user herein who is central, and not the software application that the user wishes to use, in contrast with known systems. Those who have installed the application currently designated by its common abbreviation app, is able to manage himself the exchange of people's data across various applications and platforms. The app is based on the principle of scanning and pins.

As an extension, during the authentication process the mobile client may according to the invention also ask for confirmation for other items, such as confirming and configuring the privacy settings of an account, accepting terms and conditions, or completing a payment by selecting payment credentials. By doing so the user not only proves who he/she is, but at the same time complies with all other requirements to get access to the protected resource.

This invention also relates to a device intended to carry out the method concerned as set out above, comprising the basic embodiment to carry out the linked method. With respect to the user experience, it consists of 2, optionally 3, main steps:

1. Scan a QR tag

2. Confirm the context by entering a PIN code

3. Optionally, confirm or configure additional items

2.1 Registration

The process in which a user attaches a mobile device to his user account is called the “registration” process.

1. The user is authenticated or created by the system through some other trusted process

2. The user installs the linkID mobile authentication application on his mobile device

3. The system presents a QR code to the user

4. The user scans the QR code

5. The user verifies the context on display on his mobile device

6. The user chooses and confirms his PIN code

7. The user confirms or configures additional items

8. The system registers the mobile device to the user account.

2.2 Authentication

In the authentication process the system tries to identify and authenticate a person who tries to access a protected resource.

1. The user tries to access or use a protected resource

2. The system presents a QR code to the unknown user

3. The user scans the QR code

4. The user verifies the context on the display of his mobile device

5. The user enters his PIN code

6. The user confirms or configures additional items

7. The system grants the now known user access to the protected resource.

3 Algorithm

The solution according to the invention consists of a mobile application and a server application. The user holds the mobile device with the mobile application installed and is at the same time in contact with the server application through another display (like a browser for example).

The mobile application and the server both carry a persistent state. These states change through interaction between mobile application and server application. The sections below describe these interactions and state changes.

3.1 Persistent State

The mobile application state is quite simple. At any time it holds two items:

RegistrationID This is a UUID which is created during the registration process. It is the link between a registered mobile device and a user account on the server application.

OTP This is a UUID which serves as a One-Time-Password to authenticate this mobile device to the server application. It can only be used once.

The server application state consists of registration records and session records. The registration record holds:

RegistrationID This references a registered mobile device (see mobile application state).

PIN This is a 4 digit number. It is chosen by the user at registration time.

OTP1 This is a first candidate OTP as possibly stored in the mobile application.

OTP2 This is a second candidate OTP as possibly stored in the mobile application.

Counter This is a value that counts the number of consecutive failed logins with a wrong PIN code.

Blocked This indicates if this registration is blocked and thus cannot be used to authenticate.

Activated This field indicates if this registration has been completed.

Device name This is a human readable identifier of the device for management purposes.

Current session This is the session ID of the current authentication or registration session for this registration record.

The session records of the server application hold:

SessionID This is a reference to the session used during client server communication and in the registration record's current session.

Status This field tells if this session was successfully authenticated.

Start date This tells when the session was started. This field is used to expire old sessions.

RegistrationID This links this session to a specific registration record.

The registration starts out with a user which is authenticated by the server application using any sufficiently trusted means. This authentication allows the user to start the mobile registration process on the server application. The following sections show in order what happens on client and server side. FIG. 1 shows a diagram of the complete registration process.

3.2.1 Fetching Authentication/Registration Context

The context is a string that will be displayed after scanning the QR so the user can verify that the tag he just scanned indeed relates to what he is seeing on the main screen, the browser for example. It can also optionally contain the logo of the application the user is authenticating for. This context is fetched by the client right after the QR code is parsed successfully. The sessionID from the OR code is used to retrieve the context from the server.

3.2.2 Generate a QR

The server generates a QR code. This OR code is an encoded url which is defined as:

URL=<urlhandler>://reg/<version>/<SessionID>

QR=encode(URL)

The urlhandler is a string which makes that this URL will be opened by the mobile client application if the QR were to be scanned by a generic QR scanning application.

The literal reg string tells the mobile client to enter the registration procedure instead of an authentication procedure.

The version indicates the version of the authentication protocol so the client can react appropriately if a QR of an unsupported protocol is scanned.

The Session ID is a random number, length 6 in base 62 encoding, used for retrieving the context of this registration.

The server side state is changed by adding a session in the session records. The session record looks like this:

| SessionID | Status | Start | RegID |
|---|---|---|---|
| <SessionID> | IN PROGRESS | <current time> | <RegID> |

At the same time the server enters a record in its registration table:

| RegID | PIN | OTP | OTP′ | counter | blocked | activated | device name | session |
|---|---|---|---|---|---|---|---|---|
| <RegID> | — | — | — | 0 | NO | NO | — | <SessionID> |

The SessionID is a type 4 UUID.

The QR tag is now shown to the user within the previously authenticated context.

3.2.3 Submit Registration Data

The user's mobile client scans the QR, decodes and parses the URL. Alternatively, the URL can be scanned by a generic QR scanning application or, if displayed in a web page, it can be clicked by the user. The specific URL handler in the QR code will launch the mobile authentication application according to the invention.

The mobile client extracts the sessionID from the URL and uses it to fetch the context that will be displayed to the user later on. The mobile client then connects to the server on a hardcoded SSL protected URL and submits the sessionID. The server returns the context message and an optional application logo to present to the user.

Because of the reg string literal in the URL, the mobile client enters the registration procedure. The mobile client presents the context message to the user and prompts the user to choose and confirm a reproducible knowledge factor, mostly a PIN code.

The mobile, again connecting to the same server within the same session, submits: chosen PIN and a human readable identifier of the device.

The server checks if the session is still valid and the associated client is not yet activated. If good the server checks the pin format (length==4).

If all is good, an OTP is created (UUID) and stored in the registration record and the OTP and registration ID is returned to the client. The PIN code is also stored in the registration record. The registration record looks like this:

| RegID | PIN | OTP | OTP′ | counter | blocked | activated | device name | session |
|---|---|---|---|---|---|---|---|---|
| <RegID> | <PIN> | <OTP> | — | 0 | NO | NO | <name> | <SessionID> |

The server responds to the mobile client by sending the OTP, registrationID and a list of optional items to be confirmed or configured.

Upon reception of the OTP and registration ID the client updates its persistent state:

| RegID | OTP |
|---|---|
| <RegID> | <OTP> |

The client then presents the items to be confirmed and configured to the user and records the user's input.

3.2.4 Commit Registration

The mobile client, still in the same server session, sends a commit message. The commit message contains the recorded answers to the optional items to be confirmed or configured. The server looks up the session and checks if it is not yet expired. If all is good, the server updates the registration record:

| RegID | PIN | OTP | OTP′ | counter | blocked | activated | device name | session |
|---|---|---|---|---|---|---|---|---|
| <RegID> | <PIN> | <OTP> | — | 0 | NO | YES | <name> | <SessionID> |

and the session record:

| SessionID | Status | Start | RegID |
|---|---|---|---|
| <SessionID> | SUCCESS | <current time> | <RegID> |

The authentication starts out with a user which is not known by the server application. This unknown user starts the mobile authentication process on the server application. The following sections show in order what happens on client and server side. FIG. 2 shows a sequence diagram of the complete authentication process thereof in said management system of the invention as described more in detail below.

3.3.1 Generate a QR code

The server generates a QR code in about same way as it is generated during registration:

URL=<urlhandler>://auth/<version>/<sessionID>

QR=encode(URL)

The sessionID is again used to fetch the context of the authentication in the same way it is done during registration.

The server side state is changed by adding a session in the session records. The session record looks like this:

| SessionID | Status | Start | RegID |
|---|---|---|---|
| <SessionID> | IN PROGRESS | <current time> | — |

The QR tag is now shown to the unknown user.

3.3.2 Submit Authentication Data

The user's mobile client scans the QR, decodes and parses the URL. As during the registration the QR can be scanned by a generic QR scanner or the URL can be opened by clicking on the QR tag. Because of the auth literal in the URL the mobile client enters the authentication procedure.

Using the sessionID from the QR, the client retrieves the context and optional application logo for this authentication by connecting to the server on a hardcoded SSL protected URL.

The mobile client presents the context message to the user and prompts the user to enter his knowledge factor, most often a PIN code, thereby to confirm.

The mobile client, in the same server session submits: the RegID, PIN and the OTP where RegID and OTP are obtained from the mobile client's local persistent state.

The server checks if the session exists and is still valid.

The server checks if the registration record (Reg ID) is activated and not blocked. If it is blocked the server aborts the authentication process.

The server checks if the OTP matches one of the OTP values that are stored in the registration record matching the RegID parameter. If none of the OTP values matches the submitted values the registration record can be marked as blocked. This prevents any future authentication attempts until unblocked by some registration procedure.

The server also checks if the PIN code matches the PIN code that is stored in the registration record matching the RegID parameter. If the submitted PIN code does not match the PIN code in the server's persistent state a PIN failure counter can be increased. If the PIN failure counter exceeds a configured threshold the registration record can be marked as blocked. The PIN counter can be reset to zero after every successful authentication attempt.

If all checks are passed the server generates a new OTP (OTP') and stores it in the non-matching OTP field of the registration record. The resulting server state for the registration record is:

| RegID | PIN | OTP | OTP′ | counter | blocked | activated | device name | session |
|---|---|---|---|---|---|---|---|---|
| <RegID> | <PIN> | <OTP> | <OTP′> | 0 | NO | YES | <name> | <SessionID> |

and for the session record:

| SessionID | Status | Start | RegID |
|---|---|---|---|
| <SessionID> | IN PROGRESS | <current time> | <RegID> |

The OTP' and the optional items to be confirmed or configured are sent back to the mobile client.

Upon reception of the OTP' value the client updates its persistent state:

| RegID | OTP |
|---|---|
| <RegID> | <OTP′> |

The client then presents the items to be confirmed and configured to the user and records the user's input.

3.3.3 Commit Authentication

The mobile client now sends a commit call within the same session. The commit message contains the recorded answers to the optional items to be confirmed or configured. The non-matching OTP from the previous call is removed so the server's persistent state looks like this:

| RegID | PIN | OTP | OTP′ | counter | blocked | activated | device name | session |
|---|---|---|---|---|---|---|---|---|
| <RegID> | <PIN> | <OTP′> | — | 0 | NO | YES | <name> | <SessionID> |

Only now the server marks the user server session as authenticated:

| SessionID | Status | Start | RegID |
|---|---|---|---|
| <SessionID> | SUCCESS | <current time> | <RegID> |

The algorithm is designed as such to have 2 important side-effects. The first side effect is that if the mobile client's persistent state were to be copied and successfully used subsequently then on a first use of the original client the registration entry would be blocked. This is because if a client successfully authenticates the OTP is changed so a copied client will carry an out-of-date OTP. If a non-matching OTP is sent to the server, the server can block the account.

A second side effect is that the client can never get out-of-sync with the server because of client-side or network failure. In other words: no matter when or how the client loses contact with the server during authentication, the client will just work -maybe after a client restart—as soon as the problem conditions are resolved. The reason for this is that the OTP is rolled over in a 2 phase commit: the OTP values are only rolled over after the client has stored the new OTP value.

Further features and particularities of the invention are defined in corresponding appended subclaims.

Further details are set out more in detail in the description hereinafter which is illustrated by means of the appended drawings.

### BRIEF DESCRIPTION OF THE DRAWINGS

FIG. 1 shows a sequence diagram of the registration process in a first embodiment of the system according to the invention;

FIG. 2 shows a sequence diagram of the authentication process thereof;

FIG. 3 shows a diagram of the complete registration process in a first main embodiment of the management system of the invention;

FIG. 4 shows a diagram of the entire authentication process in said basic main embodiment of the management system of the invention;

FIG. 5 shows a schematic representation of a payment application supported on the link system according to the invention.

FIG. 6 shows a block diagram of a conventional application-oriented identity model management system from the known prior art.

FIG. 7 shows a block diagram of a conventional user-oriented identity model according to a basic main embodiment of the management system.

FIG. 8 shows a block diagram of a variant of an identity model from the prior art.

FIG. 9 shows a block diagram of a variant of a user-oriented identity model management system.

FIG. 10 is a schematic presentation of the identity components used in the management system according to the invention.

FIG. 11 is a schematic presentation of the parties involved in the management system according to the invention.

FIG. 12 is a flow diagram as a schematic representation of the operation of the management system according to the invention.

FIG. 13 shows a block diagram of a conventional application-oriented identity model according to a particular application example of the invention.

FIG. 14 is a schematic presentation of an exemplary embodiment of the method according to the invention.

FIG. 15 shows a block diagram of an application-oriented identity model according to an additional application example according to the invention.

### DESCRIPTION

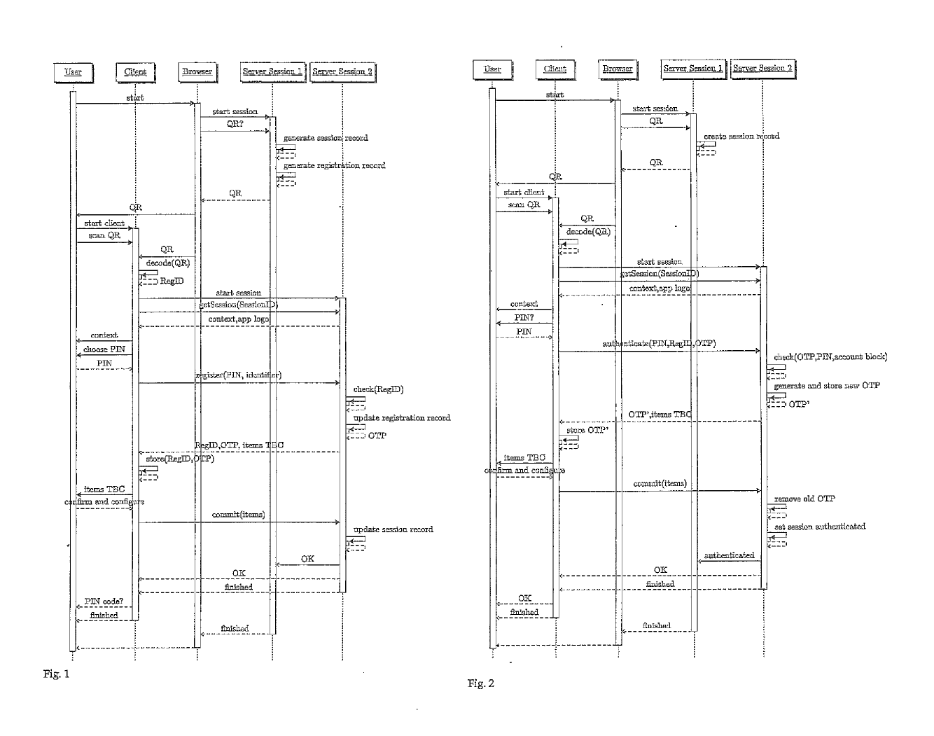

FIG. 1 shows a sequence diagram for the registration process of the system according to the invention as described below, wherein the invention relates to a mobile authentication system in which the applied users experience consists of two main steps including Scanning a QR tag and confirming the context by entering a PIN code. Optionally, there is confirming or configuring additional items.

In a main embodiment of the present invention, a process is proposed wherein the user links his mobile device to a users account, which constitutes the registration process. The process in which a user attaches a mobile device to his user account is called the “registration” process.

The Registration thus includes the following steps:

the user is authenticated or created by the system through some other trusted process;

the user installs the linked mobile authentication application on his mobile device;

the system presents a QR code to the user;

the user scans the QR code;

the user verifies the context on display on his mobile device;

the user chooses and confirms his PIN code;

the user confirms or configures additional items;

the system registers the mobile device to the user account.

As to the subsequent authentication process, the system tries with same to identify and authenticate a person who tries to access a protected resource as follows:

the user tries to get access or use a protected resource

the system presents a QR code to the unknown user

the user scans the QR code

the user verifies the context on the display of his mobile device

the user enters his PIN code

the user confirms or configures additional items

the system grants the now known user access to the protected resource.

The solution proposed according to the invention notably supported on an algorithm consists of a mobile application and a server application. The user holds a mobile device with the mobile application installed thereon, and is at the same time in contact with the server application through another display, like a browser on his PC for example.

The mobile application and the server both carry a persistent state. These states change through interaction between mobile application and server application. The sections below describe these interactions and state changes.

In said Persistent state, the mobile application state is quite simple. At any time it holds two items:

the RegistrationID, which is a UUID that is created during the registration process. It is the link between a registered mobile device and a user account on the server application; and

the OTP, which is a UUID that serves as a One-Time-Password to authenticate this mobile device to the server application. It can only be used once.

The server application state consists of registration records and session records. The registration record holds the following fields:

said RegistrationID. This refers to a said registered mobile device;

a PIN, which is a 4 digit number. It is chosen by the user at registration time;

OTP1 as first candidate OTP such as possibly stored in the mobile application;

OTP2 as second candidate OTP such as possibly stored in the mobile application;

Counter is a value counting the number of consecutive failed logins with a wrong PIN code;

Blocked indicating if this registration is blocked and can thus not be used to authenticate;

Activated wherein this field indicates if this registration has been completed;

Device name which is a human readable identifier of the device for management purposes. This name is displayed during the management of a user account;

Current session which is the session ID of the current authentication or registration session for this mobile registration record.

The session records of the server application hold:

QRhash which is a value that is the so-called hash of the QR tag that was generated for that session;

SessionID which is a reference to this session used during client/server communication and in the registration record's current session;

Status which is a field that tells if this session was successfully authenticated;

Start date: this tells when the session was started; this field is used to expire old sessions.

RegistrationID, which links the session to a specific registration record.

The registration starts out with a user which is yet authenticated by the server application using any sufficiently trusted means. This authentication allows the user to start the mobile registration process on the server application. The following sections show what happens on client and server side. FIG. 3 shows a diagram of the complete registration process.

The server generates a QR code. This QR code is an encoded URL which is defined as:

URL=<urlhandler>://reg/<version>/<RegistrationID>/<context>

QR=encode(URL).

The URLhandler is a string which makes that this URL will be opened by the mobile client application according to the invention, if the QR were to be scanned by a generic QR scanning application.

The literal reg string tells the mobile client to enter the registration procedure instead of an authentication procedure.

The version indicates the version of the authentication protocol so the client can react appropriately if a QR of an unsupported protocol is scanned.

The RegistrationID is a random number in the UUID format that will serve as identification of this registered device during the further registration or a later authentication.

The context is a text that will be displayed after scanning the QR code enabling the user to verify that the tag which he just scanned indeed corresponds to what he currently sees on the main application.

The server side state is changed by adding a session in the session records, which session record is represented in the following table 1:

TABLE 1

| QRhash | SessionID | Status | Start | RegID |
|---|---|---|---|---|
| <QRhash> | <SessionID> | IN PROGRESS | < current time > | <RegID> |

At the same time, the server adds a registration as represented in the following table 2

TABLE 2

| RegID | PIN | OTP | OTP' | Counter | blocked | activated | Device name | session |
|---|---|---|---|---|---|---|---|---|
| <RegID> | — | — | — | 0 | NO | NO | — | <SessionID> |

wherein QRhash=securehash(URL).

This securehash function is a so-called hashing function which is known as SHA1. The SessionID is a random UUID.

The QR tag is now displayed to the user within the previously authenticated context.

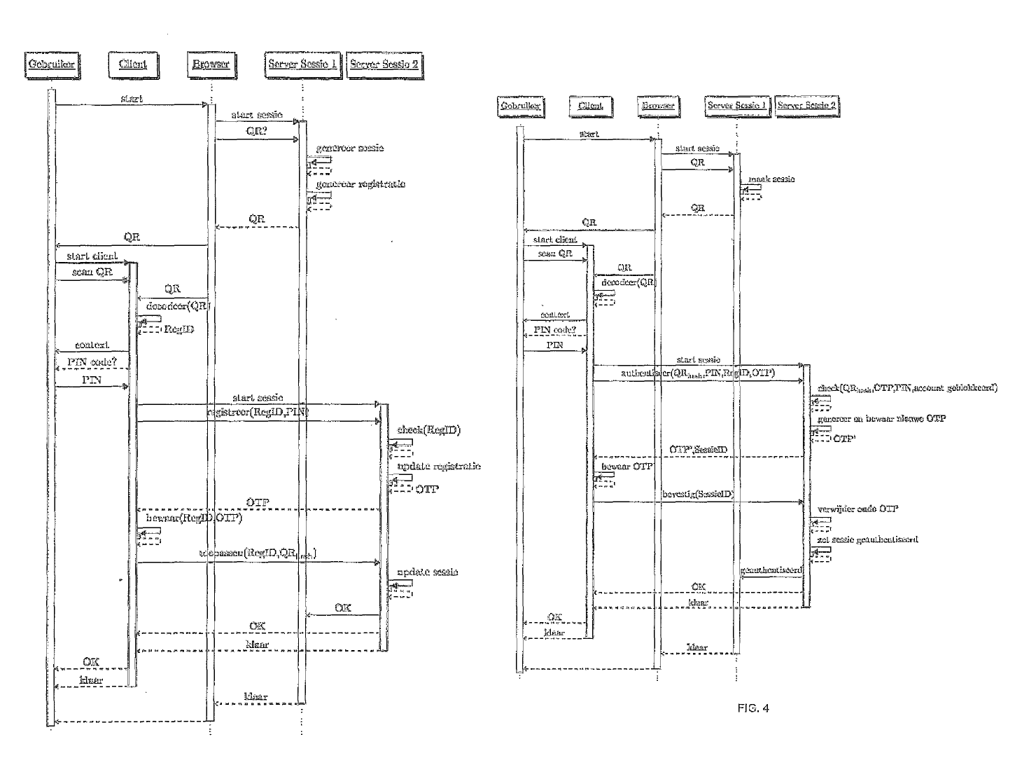

FIG. 3 further shows a diagram of the complete registration process in a management system of the invention, resp. FIG. 4 a diagram of the complete authentication process. Registration data are submitted as follows: the user's mobile client scans the QR code, decodes and parses the URL. Alternatively, the URL may be scanned by a generic OR scanning application or, if displayed in a web page, it can be clicked by the user. The specific URL handler in the QR code will launch the mobile authentication application according to the invention.

Because of the reg string literal in the URL, the mobile client enters the registration procedure. The mobile client presents the context message to the user and prompts the user to choose and confirm a reproducible knowledge factor, mostly a PIN code.

The mobile client extracts the sessionID from the URL that will serve as identification for this registered device for later contacts with the server.

The mobile application then connects to the server on a fixed SSL-secured URL, and sends the following data: RegID, chosen PIN and a human readable identifier of the device.

The server checks if the Registration (RegID) exists, is not yet activated and if the current session is still valid. If all is good, an OTP is created (a random number in UUID format) and stored in the registration record. The PIN code is also stored in the registration record as represented in the following table 3:

TABLE 3

| RegID | PIN | OTP | OTP′ | Counter | blocked | activated | Device name | session |
|---|---|---|---|---|---|---|---|---|
| <RegID> | <PIN> | <OTP> | — | 0 | NO | NO | <name> | <SessionID> |

The server responds to the mobile client by sending the OTP thereto. Upon reception of the OTP the client updates its persistent state as represented in the following table 4:

TABLE 4

| RegID | OTP |
|---|---|
| <RegID> | <OTP> |

The commit of the registration happens as follows: the mobile client, still in the same server session, now sends the QRhash and the RegID as a commit message to the server. The server validates by looking up if this hash matches the hash of the current session of the registration. The server also checks if the session is not yet expired. If all is good, the server updates the registration record as represented in the following table 5:

TABLE 5

| RegID | PIN | OTP | OTP′ | Counter | blocked | activated | Device name | session |
|---|---|---|---|---|---|---|---|---|
| <RegID> | <PIN> | <OTP> | — | 0 | NO | YES | <name> | <SessionID> |

and also the session record as represented in the following table 6:

TABLE 6

| QRhash | SessionID | Status | Start | RegID |
|---|---|---|---|---|
| <QRhash> | <SessionID> | SUCCESS | < current time > | <RegID> |

With regard to the authentication, it begins with a user who is unknown from the server application. This unknown user starts the authentication process on the server. The following sections show what happens successively in the mobile application and the server application. FIG. 4 shows a diagram of the complete authentication process.

The server generates a QR code in fairly the same way as during the registration:

URL=<urlhandler>://auth/<versie>/<seed>/<context>

QR=encode(URL).

The seed is a random string to make the URL and QR different for each session. the server state is adapted by adding a session. The session is as represented in the following table 7:

TABLE 7

| QRhash | SessionID | Status | Start | RegID |
|---|---|---|---|---|
| <QRhash> | <SessionID> | IN PROGRESS | < current time > | — |

wherein QRhash is generated in the same way as during the registration. The QR tag is now shown to the unknown user.

Submitting authentication data then takes place as follows:

the user's mobile client scans the QR code, decodes and parses the URL. As during the registration, the QR can be scanned by a generic QR scanner or the URL can be opened by clicking on the QR tag. Because of the auth string literal in the URL the mobile client enters the authentication procedure. The mobile client presents the context message to the user and prompts the user to enter his knowledge factor, mostly a PIN code.

The mobile client then connects with the server session on a hardcoded SSL protected URL and submits: the RegID, PIN and the OTP, where RegID and OTP are obtained from the mobile client's local persistent state.

The server checks if the session (QRhash) exists and is still valid.

The server checks if the registration record (RegID) is activated and not blocked. If it is blocked, the server aborts the authentication process; the server checks if the OTP matches one of the OTP values that are stored in the registration record matching the RegID parameter. If none of the OTP values matches the submitted value, the registration record is marked as blocked. This prevents any future authentication attempts until unblocked by some sufficiently trustful registration procedure.

FIG. 2 shows the sequence diagram for the authentication process.

The server also checks if the PIN code matches the PIN code that is stored in the registration record matching the RegID parameter. If the submitted PIN code does not match the PIN code in the server's persistent state, a PIN failure counter is increased by the server. If the PIN failure counter exceeds a configured threshold, the registration record is marked as blocked. The PIN counter is reset to zero after every successful authentication attempt.

If all checks are passed, the server generates a new OTP (OTP') and stores it in the non- matching OTP field of the registration record. The resulting server state for the registration record is then as represented in the following table 8:

TABLE 8

| RegID | PIN | OTP | OTP′ | Counter | blocked | activated | Device name | session |
|---|---|---|---|---|---|---|---|---|
| <RegID> | <PIN> | <OTP> | <OTP′> | 0 | NO | YES | <name> | <SessionID> |

and for the session record as represented in the following table 9:

TABLE 9

| QRhash | SessionID | Status | Start | RegID |
|---|---|---|---|---|
| <QRhash> | <SessionID> | IN PROGRESS | < current time > | <RegID> |

The OTP' and SessionID values are sent back to the mobile client.

Upon reception of the OTP' and SessionID values, the client updates its persistent state as represented in the following table 10:

TABLE 10

| RegID | OTP |
|---|---|
| <RegID> | <OTP′> |

The client then presents the items to be confirmed and configured to the user and records the user's input.

For sake of authentication committing, the mobile client sends a last commit message to the server within the same session. The non-matching OTP value from the previous interaction is removed. The server's persistent state looks like it is represented in the following table 11:

TABLE 11

| RegID | PIN | OTP | OTP' | Counter | blocked | activated | Device name | session |
|---|---|---|---|---|---|---|---|---|
| <RegID> | <PIN> | <OTP′> | — | 0 | NO | YES | <name> | <SessionID> |

Only now the server marks the user server session as authenticated as represented in the following table 12:

TABLE 12

| QRhash | SessionID | Status | Start | RegID |
|---|---|---|---|---|
| <QRhash> | <SessionID> | SUCCESS | <current time> | <RegID> |

The algorithm implemented for the system according to the invention is designed such as to have 2 important side-effects. The first side effect is that if the mobile client's persistent state were to be copied and successfully used subsequently then on a first next use of the original client the registration entry would be blocked by the server. This is because the original state will contain an OTP that will no longer be on the server and if a client successfully authenticates the OTP which is changed, a copied client will thus carry an out-of-date OTP. If a non-matching OTP is sent to the server, the server blocks registrations for which an invalid OTP is submitted and it can block the account.

A second side effect is that the mobile client can never get out-of-sync with the server because of client-side or network failure. In other words: no matter when, where or how the client loses contact with the server during authentication, the client will just work again (maybe after a client restart) as soon as the temporary connection problem conditions are resolved. The reason for this is that the OTP is rolled over in a 2 phase commit: the OTP values are only rolled over after the client has stored the new OTP value.

By way of example, a payment application according to the link system is shown schematically in a user-friendly manner in FIG. 5/10, in which the link system cloud 99 is centrally displayed, and which can be activated with the user 61 via his mobile device 62, in this case a mobile phone.

FIG. 6 and following ones show the system in general according to an embodiment relating to authentication systems that differ from the known systems 1 in that the latter are oriented on an application basis with the disadvantage of entailing severe limitations, both for users 3 and for agents or service providers of the aforementioned applications, as shown in FIG. 6. This shows the condition wherein a user 3 possesses one specific identity 13, 14, 15 for each online application a, b, c, possibly operated by the same owner, wherein the respective specified identities 13, 14, 15 may also differ in specific cases. Three identity fields 13, 14, 15 are thus to be considered.

In contrast, the linked identity management system 2 which is oriented towards the user 3 shown in FIG. 7 presents none of the aforementioned limitations of the application-oriented models of the management system 1. Instead, this creates new service possibilities for application owners or operators and offers user-friendly access to more useful applications by the users 3.

The management system 2 forms a unified identity management system which is oriented towards the user 3, and the aim of which consists in creating a unified identity model 23 intended for users within a specific region or industry. This user is therefore able to use the same account to identify himself and authenticate this for different applications a, b, c, wherein these applications can originate from different application owners. This is shown schematically in FIG. 7 with reference to the schematic representation of the current condition shown in FIG. 6.

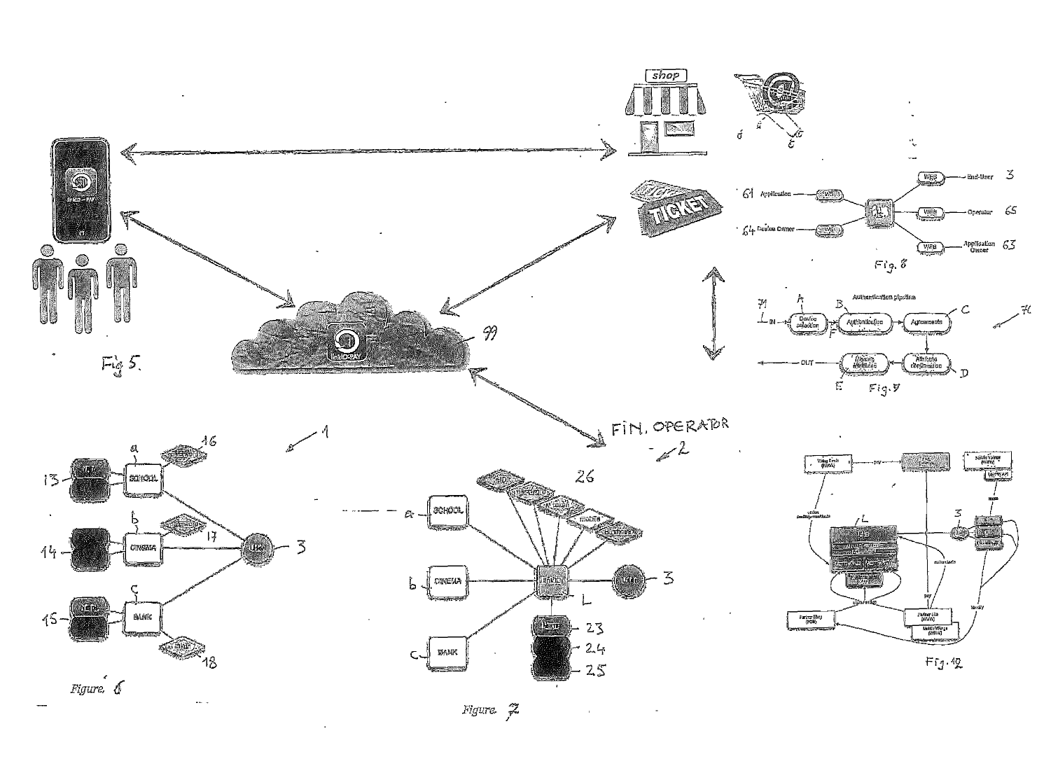

In the additional example shown in FIG. 8, applications 31 and 32 are operated by the same owner AA, wherein they can share the same identity 35. Herein, the user 30 has one specific identity 35, 36, 37 for each online application 31, 32, 33, 34 separately, possibly operated by the same owner AA or BB, wherein the respective specified identities 35, 36, 37 may differ from one another. In any event, a minimum of 3 identity fields 35, 36 and 37 are to be considered with this example.

However, the user-oriented management means L according to the invention offers a simplification of the existing system by offering a unified identity field 40 that can thus be used for the aforementioned applications 31, 32, 33, 34 simultaneously, which can also be operated by a plurality of aforementioned application owners AA or BB, as shown in FIG. 7.

The main embodiment of the invention can thus be determined as a management system L of the identity fields 40 of a user 3 who is identified by one global unified identity 40 which he must enter in order to gain access to his required applications 31, 32, 33, 34 which are operated by agents AA, BB, which is noteworthy in that this management system 2 is oriented towards the user 3, wherein the latter can gain access to all of the aforementioned applications 31, 32, 33, 34 which differ from one another, via one single identity field 40 which uniquely identifies the aforementioned user.

The advantage thereof is clearly that a global unified identity field 40 is obtained thanks to the system 2.

Identity components 51, 52, 53, 54 thus arising intervene in the unified identity 40 which is created by this system 2 and comprise four different components which are all connected via the core element L, shown schematically in FIG. 10.

The first component consists of so-called attributes 52, consisting of pieces of data which have been allocated to the physical person who possesses the identity concerned in his capacity as user 3, such as name, age, gender, town, etc. A further component consists of subscriptions 51 which determine the applications 31, 32, 33, 34 in which the identity 40 concerned can be used. These accessions 51 form the link between an application and an identity. These similarly control the legal and confidentiality compliance between a user and an application that the latter wishes to orient.

A further component concerns the authentication means 53 which are intended to be registered and used by a user 3 to authenticate himself. Here, one specific identity 40 may have registered a plurality of authentication means, and examples of this are the username/password pair, an identity card, a conventional credit card, a mobile telephone, etc.

Finally, there is the historical component 54, wherein the user 3 can keep track of all actions relating to his identity 40.

The management system 2 can guarantee the uniqueness of the user 3 by means of his devices 53, on the understanding that the core L will not allow a physical device to be used for two different accounts, thereby making the identities in this management system 2 particularly strong.

Attributes 52 form the substance of the identity 40 of the user 3, and make the user what he ultimately is. The essence of attributes lies in their repeated use between different applications 31, 32, 33, 34, wherein the user can check at any time which application provides access to which attribute. Attributes 52 have determined data types, such as e.g. Boolean or string characters, and can be linked to single or even multiple values. The attributes can also be combined to form new data types, e.g. a street combined with a city together form the address. It should be noted that attributes are not hard-coded but can be added by the operator at the request of its customers, i.e. the application owners.

In the general structure of the system 2, there is the noteworthy core element L thereof, which assumes a central position therein, wherein it communicates with different parties which are determined as follows, as shown in FIG. 11. End users 3 are formed by physical persons who have an account and who wish to use applications 61 which are linked to the core L of the management system 2. The end users interact with the system core L by means of an interface 62, e.g. a web interface, wherein integration with non-web systems is also possible.

A further party is formed by the applications 61, which are intended to perform functions consisting in specific services which are offered to the aforementioned end users 3. In order to be able to identify their users 3, they then use the aforementioned core L. In order to communicate with the core L, they use web services 62.

There are also application owners or operators 63 who own and operate the aforementioned applications. They are the actual customers of a core operator 64. They enter into interaction with the core L by means of a web application which provides statistics and accounting relating to the applications which they own.

Furthermore, there are also the operators 65 who manage the system software in so-called data centres and who sell the various system functions and services to the aforementioned application owners 63. Here, they work together with the aforementioned application owners to have their applications 61 connected to the management system L.

Finally, there are also the device suppliers who supply the necessary authentication means 53 to the users 3. They can have their device 53 carried by the management system 2, which is understood to mean that this is formed by the so-called LinkID system.

Attribute values can be obtained by the user himself 3, by an application 61, by a device 53, a remote system such as a database, a web service, LDAP, or also from a calculation of other attributes. An attribute can be read in by an application 61 if the following conditions are met, namely that the operator gives the application access to the attribute, the user 3 gives permission to the application 61 to use the attribute and finally that the attribute has a value. A further advantageous characteristic of attributes is that they can be designated as being anonymous. In this case, applications 61 cannot read in the specific value of an attribute from a specific user, but they are nevertheless able to receive statistics relating thereto. Thus, if a location was designated as anonymous for an application e.g., this application cannot read in the location of a specific person X, but it can nevertheless receive a statistic of the type “20 % of your users live in a town Y”, which forms particularly useful information for the application owner 63, and is then also a trump card of this management system L.

Different functions can be performed here by the system 2 in respect of the applications, namely first an authentication function: if an application calls on this function, the user is authenticated by the system 2 in the use of one of his configured devices 53. Provided that this runs successfully, the application is notified and will then give access to the user 3.

Furthermore, there is the attribute function: an application can retrieve the attributes 52 of the user and use the values thereof in its commercial operations. Attributes can only be read in on condition that the user 3 has given his express permission to this effect.

There is also the data function, wherein an application 31 can push attributes 52 to the profile of the user 3. In this case, these attributes can be used by other applications 32, 33, 34, provided that this is permitted by the user and the supplying application.

For the end user, the advantages in the use of the management system 2 lie in a noteworthy strengthening of his accounts, the functions and the attributes and also a stronger control over his identity 40, seen from management, confidentiality and security perspectives.

For this application, more specifically the owner 63 thereof, the advantages lie primarily in device autonomy, stronger identities with higher quality profiles, simplified registration and user management, simplified legal and confidentiality compliance. This furthermore also permits a new use of the partner of the user of the application. Moreover, it also permits a lowering of the access threshold to the application. Furthermore, it underpins marketing schemes by the reading-in and provision of attributes to or from partner applications.

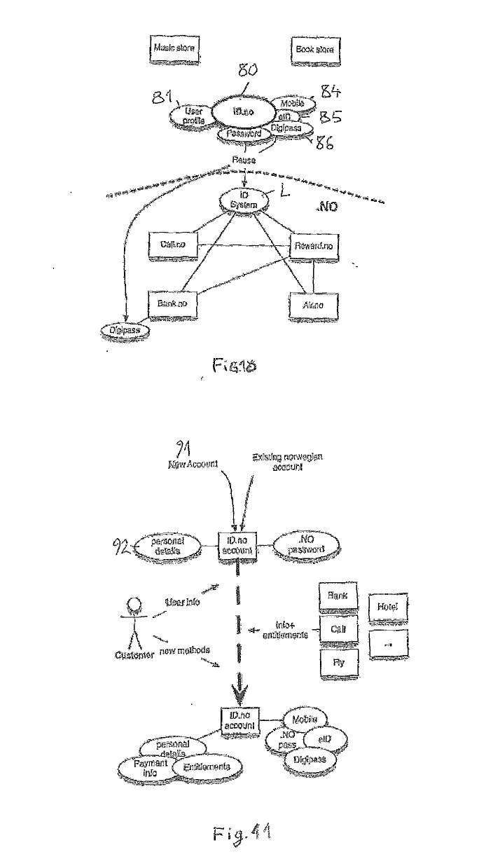

In the authentication process, an authentication flow 71 takes place which propagates according to arrow direction F via an authentication path visualized in FIG. 12 in the form of an identification pipeline 70. In order to be authenticated, the user 3 moves through various stages of the flow 71, wherein each stage provides specific guarantees to the agent or customer application. The successive steps of the authentication process are explained below.

In a first step referred to as the device selection A, the user 3 is prompted to select the authentication means 53 that he wishes to use for authentication purposes. In this way, the user can select this means 53 which he has to hand or which suits him best at that time and at that place. However, this means selection A can be restricted at the request of the application, for example only stronger authentication means for high-value transactions.

The authentication then takes place B, as required by the relevant device 53.

In the following step, which is the one of the agreements C, a general legal conformity is confirmed by asking the user 3 to express his agreement with regard to a user agreement C. This step occurs only if a new version of the user agreement is available.

Furthermore, the management system 2 asks the user 3 whether he is in agreement with the relevant application 61 using specific attributes 52. This is therefore the confirmation step D of the attributes which are determined by the aforementioned operator 65. The core L asks this once only, so that in subsequent authentication events, this step D will not occur, except if the application attribute requirements have since changed.

Finally, there is the comparison step E, where the core L compares the user attributes with the attributes retrieved by the relevant application 61. Some attributes can be designated as requested. However, in the event that the user is not provided with these attributes, the management system L will first ask the user 3 to obtain the attributes.

The authentication flow 70 described above can be incorporated into various protocols. As far as the authentication means 53 are concerned, some of these are supported in a dynamic manner by the management system 2. These elements 53 are not hard-coded in the management system 2, so that new authentication elements 53 can be added without the need for new software for the management system 2. For each authentication element 53, the management system 2 knows the location of the registration/update/deletion and authentication workflow 70. These workflows are jointly determined by the management system operator 65 and the device provider 64. These workflows 70 differ for each device 53, given that there are differences in both the technology and the delivery procedures.

The software that implements these workflows can be accommodated and processed by the management system operator 65 or by the equipment owner 64. This choice depends on a number of factors, such as security, costs and experience. In any case, the management system can use workflows from remote elements, which can be developed and maintained separately.

For a number of strongly regulated authentication elements, the operator 65 of the management system 2 does not require much cooperation from the element provider. A good example of this is the large PKI-based electronic identity card.

A number of technical choices are set out below in relation to tools and means that are used, which should not be regarded as limiting in the context of this application however. The management system 2 designated as LinkID is independent from both the operating system and the database, and it uses only open standards, in order to ensure maximum compatibility with the customer applications.

The management system according to the invention is built on an extremely flexible architecture in order to make it technology-independent. All technology-dependent components are plug-ins and can be extended. The following features have been developed in this way and can thus be extended: among the authentication means 53, mobile authentication, EMV cards, OTP tokens, etc. As far as authentication protocols are concerned: Cardspace, OpenID, windows live ID protocol, Shibboleth.

In an advantageous manner, the implementation of a signature service is similarly provided. If this service is used, an application 61 can ask the management system 2 to arrange for a user to sign a specific document or transaction with the use of his authentication elements 53. In this way, an application can use the management system 2 to strongly seal transactions in a technology-independent manner in perfect accordance with legal conformity.

If different LinkID instances are in production in different regions or industries, possibly being processed by different operators, the operating system 2 will have the facility to allow users 3 to move between these instances. Users who are connected to one management system 2 will be able to use applications that are connected to a different LinkID instance.

An overview of the advantages produced by the LinkID management system 2 is presented below. Thanks to this system, the agent or service provider can do more with the users. In this respect, application providers have a requirement for management systems that involve a larger number of users, with more applications and ultimately more revenues. This management system offers a reliable authentication which covers all the requirements, by offering their users an identification management in which they can trust.

This is done by acquiring deeper and broader levels of commitment from its user base, by allowing trust and control to be increased. Membership levels with simple management and transactions in one click intended for a migration to premium services also come into consideration here. Moreover, traffic and use increase, given that users find it more convenient and more productive to manage their use by means of one single ID which they control more effectively and can trust.

An example of a system set-up is described on the basis of the relevant FIG. 13, in which an identity service is presented, with one single identity number 80 which is confirmed by the system 2 according to the invention. This system service extends the internal identity management of the service provider to external partners. This service allows users to move freely between the agent or service provider and its partner applications, and furthermore also simply allows sharing of personal and marketing data.

This identity number service eliminates the need among specific users to take advantage of their partnership between service providers. This similarly allows exposure of service provider applications and customer data to external parties.

Application examples which can provide the sharing of the advantages or profits are known as co-branded services from the physical world, or the possibility for the sharing of payment or trusted systems between applications.

The system offers a number of important characteristics in cases where the customer is located outside the service provider area, namely in the domain of user convenience; no further need to arrange re-registration in the domain of confidentiality control, the customer can decide which data can be read in by external parties in the domain of standard interfaces for partner applications; and furthermore, in the domain of simple and reliable authentication, wherein the customer can choose from the suitable and reliable devices without the slightest integration problem for the partner application. Existing external authentication means 53, such as elDs already used or pairs of usernames/passwords 82 can be re-used 83.

Said identity system thus becomes the integration point for external applications as clearly presented in FIG. 13, where this identity number system 80 assumes a central position in the graphic, around which everything revolves, and thus acts as a type of central processing unit for the above. However, it could even be used for new or existing applications.

A strong authentication is then to be regarded as the advantage of the system according to the invention, wherein the access to an account of a management system 2 can be protected with the use of a plurality of authentication means 53 which differ in complexity and reliability. This offers a large number of advantages.

First of all, an online application may include a strong authentication if needed, for example if it is based on a transaction value. However, if a strong protection is not strictly necessary, simpler authentication methods can be used, in other words the reliability level of the authentication means 53 can be adapted to the required application 31, 32, . . . ; 61.

Furthermore, users 3 can use an authentication method as a back-up for a further method: if one method is unavailable, the user can fall back on a different method thanks to this characteristic.

Moreover, the authentication system L is completely deployable; it can at any rate support any proposed authentication mechanism and can also offer this as an authentication method to its account holders.

Authentication methods are e.g. a mobile telephone, wherein different technologies are available, notably SMS, software on the telephone or PKI on the SIM card; with password 82, wherein the management system 2 similarly supports normal username/password combinations, either as a stand-alone database or linked to an existing user base; furthermore, also an electronic identity card, wherein the management system 2 already supports the PKI electronic identity cards, i.e. presently the Belgian electronic identity card; and finally also a digipass 86, wherein the management system 2 already supports implemented digipass solutions. This digipass means 86 is available to users to certify all applications or a restricted number of applications, according to the policy adopted here by the operator of the base installed with digipass.

For the user registration, customers can obtain an account in two ways. They can either create their own account themselves, or an account is automatically converted or mirrored from an existing identity system.

In both cases, the account of the management system 2 will grow with time. The customer, agent or service provider and its partners will add data to the account. New authentication means 53 are incorporated along the way as they become available or are required for a specific application 61.

The end result is then a particularly rich account that can be used in any given commercial condition as long as all information relating to the user 3 is present and he can be identified to the extent that the new application requires. The account can then be extended into new applications without delay due to technical interfacing issues or user registration obstacles.

In short, the management system according to the invention is an appropriate means of capturing the information value of the customer file and making efficient re-use thereof.

An additional extension of the functionality of the LinkID management system according to the invention referred to as L is explained below, consisting in the development of an additional contrivance referred to as the “red button”. This essentially involves an activation means of a specific application in a specially designed format that is described below in connection with an application example in a TV broadcast.

In this format, a LinkID application is installed on a mobile terminal of the user, which may be any given mobile device that is capable of running third-party applications. Examples of this are an iPhone, an iPad, Android devices, etc.

The aforementioned application has a distinguishing logo and brand, which identifies an identity provider. In the TV world, the latter may be a broadcaster, a cable network, a media group, or an advertiser, etc. If this logo appears in a LinkID or “L”-activated TV programme or advert, the user can activate this logo by pressing it on his mobile terminal.

The L application starts up and downloads interactive content relating to this advert or TV programme from an L server, which then decides which content to broadcast, based on the time when the interactive content was requested.

This content comprises normal multimedia information material, but also actions that the user can undertake. If required, a part of these actions and content can be exclusive and specific to the user of the L application and could, in other words, not be obtained by, for example, surfing on the broadcaster, the television station or the advertising website.

A typical example of exclusive action consists in a price reduction which is offered to the viewer. The exclusive content and privileges can be immediately used via the L mobile application, or can also be used later, similarly via the L mobile application, or via a website, or also a point of sale (POS).

In order to install the aforementioned mobile application, the relevant L format requires the installation of a telephone application on the telephone terminal of the user.

A marketing campaign must convince the users to download the application free of charge from their mobile shop.

When the LinkID application is started up for the first time, the user can create an account, including a chosen account name, and may optionally choose a PIN code, again via the mobile L application. The mobile device is connected to the account that has just been created, so that any action that is carried out via the mobile terminal is charged.

The synchronization of the content takes place as follows: if the user presses on the aforementioned logo on his mobile terminal, specific content for the user is displayed, given that the application owner must be aware of the content that appears when a user presses on the aforementioned logo on his mobile terminal, the Link-ID application must be synchronized with the TV content. Given that collaboration takes place between the producers of the TV program or advertisers and the management system 2, it is known roughly when these begin.

The synchronization is obtained with the activated TV program and at least one of the following techniques: the core L is automatically informed when the programs or adverts activated with the core begin; the core L itself detects the beginning of a TV program or advert that has been activated with the core L with a touch of the screen; and/or the core L is manually configured by an operator.

In the event that different TV programs or adverts activated with the core L occur simultaneously, the core L will simply ask the user to choose which content he wants to see, or which channel he was viewing.

The sequence of the content is as follows: when a user has activated a Link-ID application by pressing on the selection means provided for this purpose during an activated or provided television program or advert, he has the facility to visualize a specific content or to perform specific actions.

In addition, the core will indicate to the account of the user that he has pressed the relevant selection means or button in a specific program or advert, the user can then transfer to a website of a producer or advertiser subject to use of his PC or mobile means and he can then further log in using his mobile application.

The website can then ask for the account of the user and check whether he has joined the current system campaign. If so, the website can give special privileges to the user. Simultaneously all required personal particulars of the user are shared with the producer/advertiser. If privacy legislation and regulation so requires, this data sharing can be carried out in such a way that the user must expressly confirm this.

The user can also claim his benefits on a point of sale POS provided that the POS software is connected online. To identify himself, the user can notify his core system, username—chosen by him on registration—to the POS operator, or he can have a barcode and the like generated by a system mobile application.

The POS software can then scan this barcode or TAG and further use it to identify the user in the system server.

Application examples of the system button are particularly in the following possible conditions by pressing the system button during an advert thanks to which the user can enjoy an exclusive price reduction on the advertiser's web shop.

Furthermore, by pressing the button various times, the user can obtain a benefit if he views all parallel-running adverts of a specific product. This means also allows a vote to be placed during a TV program in the context thereof, in a poll. Finally, pressing the system button during a TV program can provide additional content known as a bonus, or additional background information on the subject concerned.

In the context of a further extension of the functionality of the management system, a further development of the possibilities of the attributes is also explained below in FIG. 15.

Examples: some scenarios in which the so-called mobile authentication according to the invention may be used follow below. Each scenario is based on a user who has already registered.

A. For an authentication on a Web site, the user follows the next system steps:

1. a user goes to a web site; 2. the user clicks on submit;

3. the web site shows a QR code; 4. the user scans the QR code with his mobile application according to the invention; 5. the user recognizes the context of his mobile application “sign in at site X”;

6. The user enters his PIN code in the mobile application according to the invention;

7. Web site reads the successful session status and enables user to the protected part of web site.

B. For a payment on a web site, the user follows the following System Steps:

1. a user goes to a web site and composes an order; 2. the user clicks on pay;

3. the web site displays a QR code;

4. the user scans the QR code with his mobile application according to the invention;

5. the user recognizes the context of its mobile application “ pay X Euros on site Y”;

6. the user enters his PIN code in the mobile application according to the invention;

7. the web site reads the successful session state and uses the stored payment data of the user to pay the order.

C. For a payment in a physical store, the user follows the following System Steps:

1. a user goes to a store checkout; 2. the cashier clicks on pay in the POS system;

3. the cash register displays a QR code; 4. the user scans the QR code with his mobile application according to the invention;

5. the user recognizes the context of his mobile application “pay X Euros in store Y”;

6. the user enters his PIN code in the mobile application according to the invention;

7. the POS system reads the successful session state and uses the stored payment data from the user to pay the order.

D. For an access control to an event, the user follows the next System Steps:

1. a user to the access control; 2. the control system displays a QR code;

3. the user scans the QR code with his mobile application according to the invention;

4. the user recognizes the context of his mobile application “to enter event X”;

5. the user enters his PIN code in the mobile application according to the invention;

6. the control system reads the successful session state and verifies in its database whether this user actually has the right to enter.

1. System comprising a unified identity management system (2) for users (3) within a certain area on which (3) it (2) is centered to establish a unified identity means (23) by means whereof the users are able to use one single account to identify themselves and to authenticate it for various applications (31, 32, 33, 34, 61), possibly assuming different application holders (63), wherein said system allows users (3) to access multiple applications with the use of one single account, wherein the authentication process implements a two-factor authentication, which is supported on both a knowledge factor and a possession factor, with the use of specific codes, and a two-stage mechanism to set up a user experience, wherein the linked authentication mechanism is provided with mobile detection means for detecting whether there are two copies of the same mobile registration being active that take action if this is the case, wherein said dedicated user experience consists of two main steps comprising the scanning of a so-called QR tag and confirming the context by entering a PIN code, wherein the user (3) thus performs two steps by scanning a QR code and then entering the PIN code.

2. System according to claim 1, wherein the user links his mobile device to a user account according to a registration process through which he gets registered, wherein the registration consists of the following steps:
1.—the user is authenticated or created by some other trusted process
2.—the user installs the linked mobile authentication application on his mobile device
3.—the system displays a QR code to the user
4.—the user scans the QR code
5.—the user verifies the context on display on his mobile device
6.—the user selects and confirms his PIN code, optionnally optionally the user confirms and/or configures additional items
7.—the system links the mobile device to the user account wherein a QR code is an encoded URL that is generated by the server, with a subsequent authentication, wherein the system tries to identify and authenticate a person who is trying to access a protected resource during the authentication process as follows:
8.—the user tries to gain access to or use an application
9.—the system displays a QR code to the unknown user
10.—the user scans the QR code
11.—the user verifies the context on the display of his mobile device
12.—the user enters his PIN code, and/or the user confirms and/or configures additional item to the application or protected resource
13.—the system gives the presently known user access to the application or protected resource.

3. System according to claim 1, wherein the process is based on an algorithm consisting of a mobile application and a server application, wherein the user is equipped with his mobile device with the mobile application thereon, having a keyboard and a screen that may be different from the keyboard and screen of the system on which the main application is running, thereby thus generating separate screens which displays context to the user about what should happen on the main screen, thereby forming a reliable control means for the user that the main screen actually does what it states, while the separate keyboard provides a safe input for the knowledge factor, wherein the user is thus in contact with the server application through another screen, wherein both the mobile application and the server application have a persistent state and the state of both applications is changing during the interaction between the mobile application and the server application.

4. System according to claim 1, wherein the mobile device of the smart phone or tablet type has a camera which is able to quickly scan QR codes, preferably with a permanent Internet connection, both of which are used to generate a smooth and secure user experience, wherein the scanning of said QR code yields a fast and faultless synchronization of the main application and the mobile application.

5. System according to claim 1, wherein the number of codes and passwords for the user is finally reduced to one single binomial or couple, which is easier to remember, especially as a result of the structure of the system where the user is placed in the center of the system instead of the software application that he wants to use, wherein the operation of this system consists in that the user enters into a website using the system, wherein the user scans a QR code and the user then enters his PIN code on his mobile device in which he is thus authenticated, and wherein the user can also order and/or pay likewise, while he decides what information he wants to share with any application or website, and the system then remembering what data may be displayed to which application, allowing the user to keep control of his own personal information.

6. System according to claim 3, wherein the applications being used by the user, exchange their own information with each other, especially wherein said interactions and their influence on the state of both applications are determined in that said persistent state of the mobile application includes the following two items:
a registrationID, which is created during the registration process and which forms the link between the registered mobile device and the user account on the server application; and an OTP, which serves as a One-Time-Password to authenticate this mobile device to the server application, which is used only once, and
wherein the state of the server application consists of registration records and session records,
wherein said registration record comprises a number of fields, especially the following ones:
said registrationID that references an aforesaid registered mobile device;
a PIN as an n-digit number, which is chosen by the user at registration time;
OTP1 as a first candidate OTP as possibly stored in the mobile application;
OTP2 as a further candidate OTP as possibly stored in the mobile application;
“Counter” as a value that counts the number of consecutive failed authentication attempts or logins with an incorrect PIN code;
“Blocked” that indicates whether this registration is blocked and can thus not be used to authenticate;
“Activated” wherein this field indicates whether this registration has been completed;
“Device Name”, which is a human readable identifier of the registered device, wherein this identifier is displayed during the management of a user account;
“Current session”, which is the sessionID of the current authentication or registration session for this mobile registration, wherein the session records of the server application comprises;
“QRhash”, which is a value being the so-called hash of the QR tag that was generated for this session;
“SessionID” which is a reference to the session that is used during clients/server communication and in the registration data or record's current session;
“Status”, which is a field that tells whether the session was successfully completed and authenticated;
“Start time” or date which tells when the session was started, and is used to make old sessions expire;
“RegistrationID” which links this session to a specific registration record; particularly wherein the registration starts out with a user that is already authenticated by the server application using any sufficiently trusted means, and wherein this authentication enables the user to start the mobile registration process on the server application.

7. System according to claim 6, wherein the registration data are submitted wherein the mobile application of the user scans the QR code, decodes and parses the URL, or that the QR code is scanned by a generic QR scanner or, if displayed in a Web page, it is clicked by the user, wherein the specific URL handler in the QR code launches the linked mobile authentication application, wherein the mobile application starts the registration process, and wherein the mobile application displays the context to the user and asks him for a knowledge factor, especially a PIN, to select and to confirm; after which the registration is confirmed.

8. System according to claim 1, wherein the authentication starts with a user that is not known by the server application, wherein this unknown user starts the mobile authentication process on the server application, wherein the authentication process runs in the mobile application and the server application in that the server generates a QR code in an analogous manner as during registration, wherein authentication data are submitted as follows: the mobile application of the user scans the QR code, decodes and processes the URL, wherein the QR code can be scanned by a generic 1R scanner or the URL can be accessed by clicking on the tag, wherein the mobile application starts the authentication procedure, and the mobile application presents the context to the user and prompts him to enter his knowledge factor, especially a PIN, wherein the mobile application then links to the server on a fixed secure URL and the server checks whether the session exists and is still valid, the server checks whether the registration is activated and not blocked, and if blocked, the server then aborts the authentication process; wherein the server further checks whether the OTP matches any of the OTP values stored in the registration record, wherein if none of the OTP values matches the submitted value, the registration record is then marked as blocked, and in order to confirm the authentication, the mobile application then sends a last message to the server within the same session.

9. System according to claim 1, wherein if the state of the mobile application is copied and used successfully, the registration is blocked by the server at the next use of the original state, wherein the server blocks registrations for which an invalid OTP has been submitted.

10. System according to claim 1, wherein a linked mobile authentication is used by means of a mobile device of the GSM phone and/or tablet type, wherein the successive steps of the authentication process that are followed by a user for an authentication on a web site, wherein the user has already been registered are the following:
a user goes to a web site
the user clicks on log in
the web site displays a QR code
the user scans the QR code with his linked mobile application
the user recognizes the context in his mobile application “sign in at site X”
the user enters his PIN code in the linked mobile application through a mobile device of the type of mobile phone and/or tablet
the web site reads the successful session status and allows the user to the protected area of the web site;
or wherein the successive steps of the authentication process followed by a user for a payment on a web site are the following:
a user goes to a web site and composes an order
the user clicks on pay
the web site presents a QR code
the user scans the QR code with its linked mobile application
the user recognizes the context in its mobile application “X euros payable on site Y”
the user enters his PIN code in the linked mobile application
the web site reads successful session state and uses the stored payment data of the user to pay the order;
or wherein the successive steps of the authentication process followed by a user for a payment in a physical store are the following:
a user goes to a cashier store checkout
the cashier clicks on pay in the cashier POS system
the POS system displays a QR code
the user scans the QR code with its linked mobile application
the user recognizes the context in its mobile application “pay X euros in store Y”
the user enters his PIN code in the linked mobile application
the cash register reads the successful session state and uses the stored payment data of the user to pay the order.

11. System according to claim 1, further comprising a linked mobile authentication, by means of a mobile device of the GSM phone and/or tablet type, wherein the successive steps of the authentication process that a user follows for an access control to an event site are the following:
a user goes to the access control
the control system displays a QR code
the user scans the QR code with its linked mobile application
the user recognizes the context in its mobile application “to enter event X”
the user enters his PIN code in the linked mobile application
the control system reads the successful session state and verifies in its database whether the user actually has the right to enter.

12. System for providing an authenticated access to the Internet based services, in particular according to claim 1, further comprising a unified identity management system (2), which is centered on the user (3) for generating a unified identity means (23) intended for users (3) within a particular area, so that this user is able to use the same account to make himself known and to authenticate this for various applications (31, 32, 33, 34, 61), possibly based on different application owners (63).

13. System according to claim 1, wherein the user centered management means (2) is based on a combination of validation means of agreements established between a particular service provider and owners of the concerned web sites in their capacity of suppliers, to provide access for the user (3) to an Internet site he visits that is subject to the intended management system (L) when he is connected to the relevant management system (L).

14. System according to claim 12, wherein the management system (2) is aimed at the user (3), whereby the latter is able to access all of the aforementioned applications (31, 32, 33, 34) which are mutually different, and this by means of a single identity field (40) which the said user (3) unequivocally identifies, wherein said centered linked identity management system (2) provides a unified identity field (40) to the user (3) that is used for the said applications (31, 32, 33, 34) at the same time, and which is operated by multiple application holders (AA, BB).

15. System according to claim 12, wherein the globally unified identity field (40) is inserted by the user (3), which is identified by the said one globally unified identity (40), in order to have access to its desired applications (31, 32, 33, 34) which are operated by agents (AA, BB).

16. System according to claim 12, wherein the unified identity (40) that is generated by this system (2) consists of four different components (51, 52, 53, 54) all of which are connected via the core element (L), wherein the first of the said identity components (51, 52, 53, 54) consists in so-called attributes (52), which consist of pieces of data that are assigned to the physical person having the relevant identity, in his capacity of user (3); wherein a further component consists in accesses (51) that determine to which of applications (31, 32, 33, 34) the corresponding identity (40) can be used, and which (51) form the link between an application (31, 32, 33, 34) and an identity (40), and which control certain legal and confidentiality requirements between a user (3) and an application (31, 32, 33, 34) which the latter wishes to set up;
wherein a still further component consists in authentication means (53) in order to be recorded and used by the user (3) in order to authenticate himself, where a given identity (40) has recorded several authentication means (53), and finally, the history component (54) in which the user (3)
keeps a track of all the actions in connection with his identity (40).

17. System according to claim 16, wherein the various authentication means (53) are used to achieve access to the said Internet site that is connected to the management system (L).

18. System according to claim 12, wherein some of the control management means are provided with attributes (52) that are intended to determine the profile of the user (3), wherein control means thereof are provided in the management system (L) to take out the said attributes (52) and store them (52) during the course of the process (70).

19. System according to claim 18, wherein the system (L) constitutes a standard based management system for managing a standard sponsored user-oriented electronic identity (40).

20. System according to claim 12, wherein the management system (2) establishes the uniqueness of the user (3) by means of its units (53), wherein the core (L) prevents a physical device from being used for two different accounts related to the identities (40) in this management system (2).

21-41. (canceled)
